(19) United States
(12) Patent Application Publication
(10) Pub. No.: US 2025/0392403 A1
(43) Pub. Date: Dec. 25, 2025

(54) METHOD, DEVICE, AND SYSTEM FOR TIME SYNCHRONIZATION

(71) Applicant: ZTE Corporation, Shenzhen (CN)

(72) Inventors: Xiubin SHA, Shenzhen (CN); Bo DAI, Shenzhen (CN); Jie TAN, Shenzhen (CN); Yuan GAO, Shenzhen (CN); Yin GAO, Shenzhen (CN); Jianxun AI, Shenzhen (CN)

(73) Assignee: ZTE Corporation, Shenzhen (CN)

(21) Appl. No.: 18/985,907

(22) Filed: Dec. 18, 2024

Related U.S. Application Data
(63) Continuation of application No. PCT/CN2022/122253, filed on Sep. 28, 2022.

(51) Int. Cl. H04J 3/06; H04J 3/12

(52) U.S. Cl. CPC H04J 3/0667; H04J 3/12

(57) ABSTRACT

This disclosure relates generally to a method, device, and system for synchronization in a wireless network. One method performed by a wireless device is disclosed. The method may include receiving, from a first network element in a 5GS, a first message comprising clock configuration information, the clock configuration information comprising at least one of: a list of GM clocks comprising a first and a second GM clock; a clock indicator of each GM clock in the list of GM clocks; a time difference between the first GM clock and the second GM clock; receiving, from a second network element the 5GS, a first clock information for the first GM clock; in response to the first clock information, using the first GM clock as an active GM clock; and synchronizing with the 5GS based on the first clock information and treating the first GM clock as an active GM clock.

### CROSS-REFERENCE TO RELATED APPLICATION(S)

The present application is a continuation of International Patent Application No. PCT/CN2022/122253, filed Sep. 28, 2022. The contents of International Patent Application No. PCT/CN2022/122253 are herein incorporated by reference in their entirety.

### TECHNICAL FIELD

This disclosure is directed generally to wireless communications, and particularly to a method, device, and system for time synchronization and data transmission in a wireless network.

### BACKGROUND

The ecosystem in a wireless communication network includes more and more applications that require high availability, high throughput, real-time transmission, low latency, and low jitter. Time Sensitive Networking (TSN) is designed to manage latency between industrial devices in ethernet networks. There are significant benefits that can be achieved for industrial use cases with the combination of TSN and 5G system. Accurate and robust timing synchronization within the 5GS and the TSN is critical for meeting performance requirement.

### SUMMARY

This disclosure is directed to a method, device, and system for time synchronization and data transmission in a wireless network.

In some embodiments, a method performed by a wireless device is disclosed. The method may include: receiving, from a first network element in the 5GS, a first message comprising clock configuration information, the clock configuration information comprising at least one of: a list of Grand Master (GM) clocks comprising at least a first GM clock and a second GM clock; a clock indicator of each GM clock in the list of GM clocks, the clock indicator comprising at least one of: a name of the each GM clock in the list of GM clocks; an identifier of the each GM clock in the list of GM clocks; or an index of the each GM clock in the list of GM clocks; a time difference between the first GM clock and the second GM clock; receiving, from a second network element the 5GS, a first clock information for the first GM clock; in response to the first clock information, using the first GM clock as an active GM clock; and synchronizing with the 5GS based on the first clock information and treating the first GM clock as an active GM clock.

In some embodiments, a method performed by a first network element is disclosed. The method may include: transmitting, to a wireless device in the 5GS, a first message comprising clock configuration information, the clock configuration information comprising at least one of: a list of Grand Master (GM) clocks comprising at least a first GM clock and a second GM clock; a clock indicator of each GM clock in the list of GM clocks, the clock indicator comprising at least one of: a name of the each GM clock in the list of GM clocks; an identifier of the each GM clock in the list of GM clocks; or an index of the each GM clock in the list of GM clocks; a time difference between the first GM clock and the second GM clock; transmitting, to the wireless device, a first clock information for the first GM clock, wherein the first clock information indicating that the first GM clock is an active GM clock; and treating the first GM clock as an active GM clock.

In some embodiments, there is a network element or a device comprising a processor and a memory, wherein the processor is configured to read code from the memory and implement any methods recited in any of the embodiments.

In some embodiments, a computer program product comprising a computer-readable program medium code stored thereupon, the code, when executed by a processor, causing the processor to implement any method recited in any of the embodiments.

The above embodiments and other aspects and alternatives of their implementations are described in greater detail in the drawings, the descriptions, and the claims below.

### BRIEF DESCRIPTION OF THE DRAWINGS

FIG. 1 shows an example wireless communication network.

FIG. 2 shows an example wireless network node.

FIG. 3 shows an example user equipment.

FIG. 4 shows an example system architecture for 5GS acting as a TSN bridge.

FIG. 5 shows an example 5GS time synchronization with 5GS detecting grand master clock switchover.

FIG. 6 shows another example 5GS time synchronization with 5GS detecting grand master clock switchover.

FIG. 7 shows an example 5GS time synchronization with UE detecting grand master clock switchover.

FIG. 8 shows and example 5GS time synchronization with clock indicator added in timestamp.

### DETAILED DESCRIPTION

### Wireless Communication Network

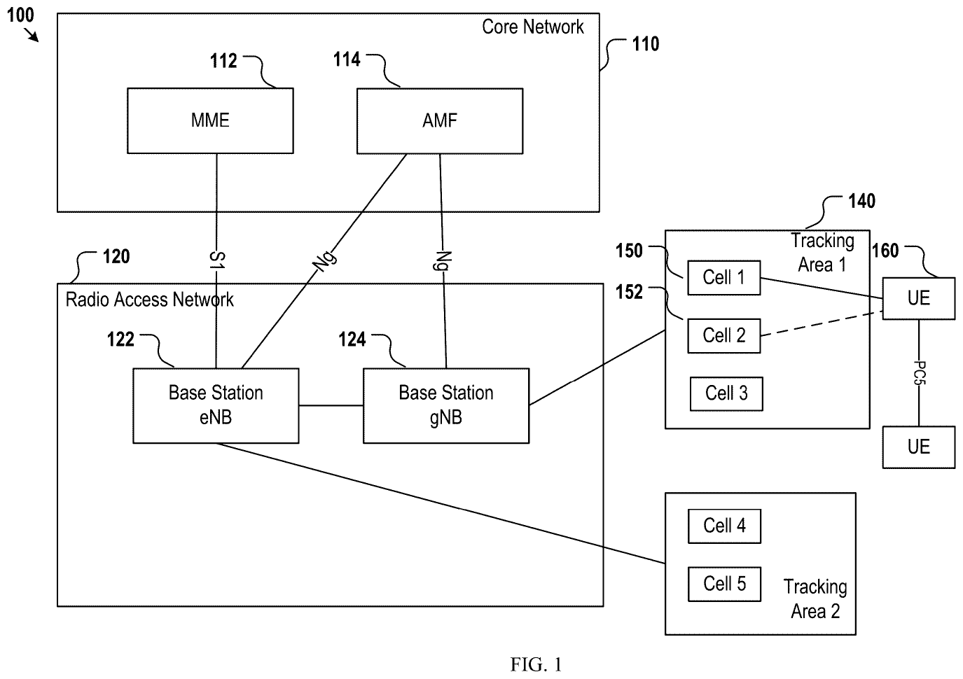

FIG. 1 shows an exemplary wireless communication network 100 that includes a core network 110 and a radio access network (RAN) 120. The core network 110 further includes at least one Mobility Management Entity (MME) 112 and/or at least one Access and Mobility Management Function (AMF). Other functions that may be included in the core network 110 are not shown in FIG. 1. The RAN 120 further includes multiple base stations, for example, base stations 122 and 124. The base stations may include at least one evolved NodeB (eNB) for 4G LTE, an enhanced LTE eNB (ng-eNB), or a Next generation NodeB (gNB) for 5G New Radio (NR), or any other type of signal transmitting/receiving device such as a UMTS NodeB. The eNB 122 communicates with the MME 112 via an S1 interface. Both the eNB 122 and gNB 124 may connect to the AMF 114 via an Ng interface. Each base station manages and supports at least one cell. For example, the base station gNB 124 may be configured to manage and support cell 1, cell 2, and cell 3.

The gNB 124 may include a central unit (CU) and at least one distributed unit (DU). The CU and the DU may be co-located in a same location, or they may be split in different locations. The CU and the DU may be connected via an Fl interface. Alternatively, for an eNB which is capable of connecting to the 5G network, it may also be similarly divided into a CU and at least one DU, referred to as ng-eNB-CU and ng-eNB-DU, respectively. The ng-eNB-CU and the ng-eNB-DU may be connected via a W1 interface.

The wireless communication network 100 may include one or more tracking areas. A tracking area may include a set of cells managed by at least one base station. For example, tracking area 1 labeled as 140 includes cell 1, cell 2, and cell 3, and may further include more cells that may be managed by other base stations and not shown in FIG. 1. The wireless communication network 100 may also include at least one UE 160. The UE may select a cell among multiple cells supported by a base station to communication with the base station through Over the Air (OTA) radio communication interfaces and resources, and when the UE 160 travels in the wireless communication network 100, it may reselect a cell for communications. For example, the UE 160 may initially select cell 1 to communicate with base station 124, and it may then reselect cell 2 at certain later time point. The cell selection or reselection by the UE 160 may be based on wireless signal strength/quality in the various cells and other factors.

The wireless communication network 100 may be implemented as, for example, a 2G, 3G, 4G/LTE, or 5G cellular communication network. Correspondingly, the base stations 122 and 124 may be implemented as a 2G base station, a 3G NodeB, an LTE eNB, or a 5G NR gNB. The UE 160 may be implemented as mobile or fixed communication devices which are capable of accessing the wireless communication network 100. The UE 160 may include but is not limited to mobile phones, laptop computers, tablets, personal digital assistants, wearable devices, Internet of Things (IoT) devices, MTC/eMTC devices, distributed remote sensor devices, roadside assistant equipment, XR devices, and desktop computers. The UE 160 may also be generally referred to as a wireless communication device, or a wireless terminal. The UE 160 may support sidelink communication to another UE via a PC5 interface.

While the description below focuses on cellular wireless communication systems as shown in FIG. 1, the underlying principles are applicable to other types of wireless communication systems for paging wireless devices. These other wireless systems may include but are not limited to Wi-Fi, Bluetooth, ZigBee, and WiMax networks.

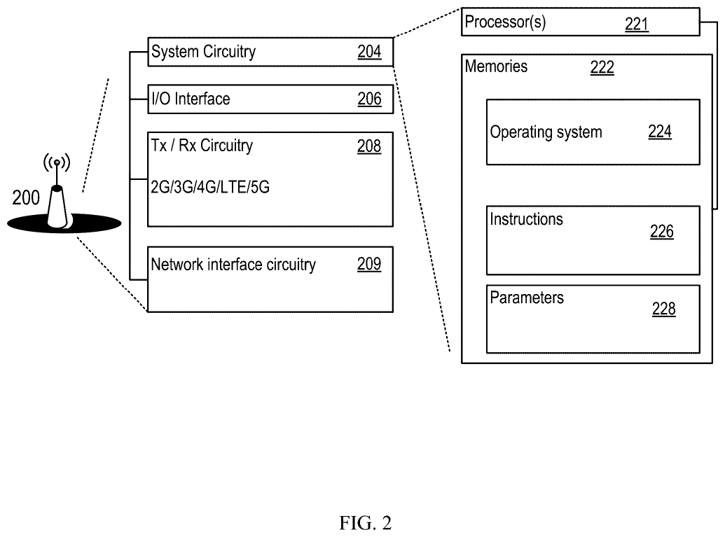

FIG. 2 shows an example of electronic device 200 to implement a network base station (e.g., a radio access network node), a core network (CN), and/or an operation and maintenance (OAM). Optionally in one implementation, the example electronic device 200 may include radio transmitting/receiving (Tx/Rx) circuitry 208 to transmit/receive communication with UEs and/or other base stations. Optionally in one implementation, the electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 221 to perform the functions of the network node. The parameters 228 may include parameters to support execution of the instructions 226. For example, parameters may include network protocol settings, bandwidth parameters, radio frequency mapping assignments, and/or other parameters.

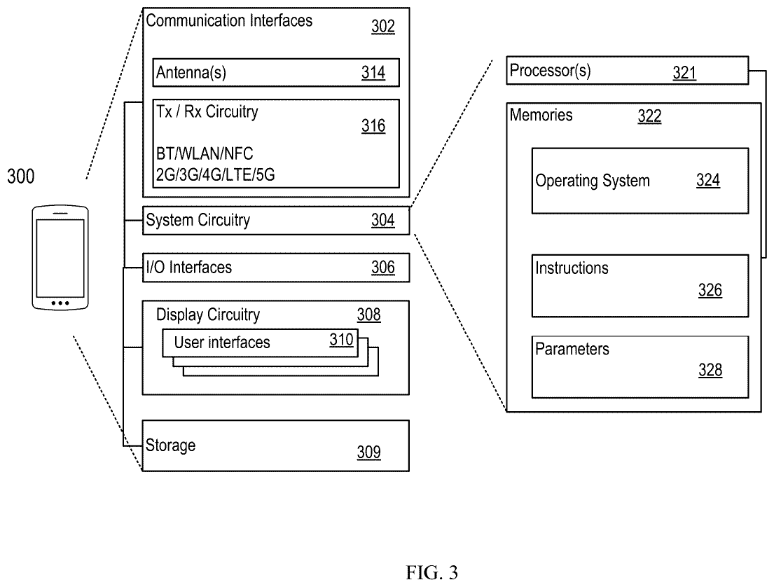

FIG. 3 shows an example of an electronic device to implement a terminal device 300 (for example, a user equipment (UE)). The UE 300 may be a mobile device, for example, a smart phone or a mobile communication module disposed in a vehicle. The UE 300 may include a portion or all of the following: communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA) +, 4G/Long Term Evolution (LTE), and 5G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G or other data that the UE 300 will send, or has received, through the communication interfaces 302. In various implementations, a system power for the UE 300 may be supplied by a power storage device, such as a battery or a transformer.

### 5G system and Time-Sensitive Networking

Wireless communications system and Time-Sensitive Networking (TSN) are key technologies for industrial communications. For example, 5G may be used for wireless connectivity and TSN may be used for wired connectivity.

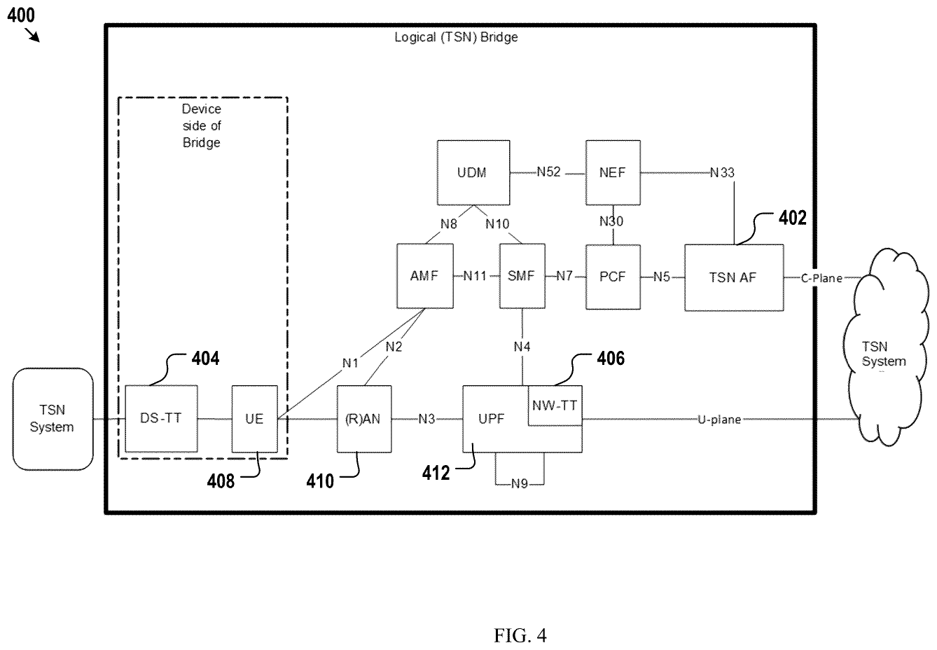

For a seamless integration between a 5G system (5GS) and a TSN system, the 5GS may act as a virtual TSN bridge of the TSN network. FIG. 4 shows an example system architecture for 5GS acting as a TSN bridge. This architecture defines several gateways between the TSN and the 5GS:
A TSN application function (AF) 402 to connect the TSN Centralized User Configuration (CUC)/Centralized Network Controller (CNC) entities and the 5G control plane.
A device-side TSN translator (DS-TT) 404 on the user equipment (UE) side.
A network-side TSN translator (NW-TT) 406 on the user plane function (UPF) side

As shown in FIG. 4, a 5GS may include a UE 408, a RAN 410, and a UPF 412. The 5GS is capable of performing time synchronization with 1 μs (microsecond) accuracy, for example, by using the following mechanism: RAN synchronizes its time with the UPF based on one of: a local on-site Global Navigation Satellite System (GNSS) receiver (e.g., both gNB and UPF receive the time from GNSS); a local on-site clock (e.g., gNB, UPF and Grand Master (GM) clock are co-located); or a cascaded Precision Time Protocol (PTP) capable transport network connection (e.g. gNB and UPF synchronize time with the GM clock via general precision time protocol (gPTP) or IEEE Standard 1588 (IEEE Standard for a Precision Clock Synchronization Protocol). The RAN may deliver its time to UE via 5G Access Stratum (AS) signaling (e.g., System Information Block (SIB), or dedicated Radio Resource Control (RRC) signaling).

As a TSN bridge, the 5GS may support generalized Precision Time Protocol (gPTP) based time synchronization between TSN end station and TSN working clock, which depends on the 5GS time synchronization. For example, during the gPTP based time synchronization between TSN end station and TSN working clock, it is assumed that a same time clock is used as the 5GS. For a data packet passing through the 5GS, based on the ingress timestamp (when the data packet enters the 5GS) and egress timestamp (when the data packet exits the 5GS) of the data packet, the 5GS transmission delay may be derived.

As a TSN bridge, 5GS may also support deterministic transmission delay, which is implemented by the hold and forward functionality implemented in DS-TT and/or NW-TT for the purpose of 5GS de-jittering. For example, for DL transmission, the burst arrival time and periodicity may be sent to the UE from AMF via a NAS message, based on which the DS-TT may determine each burst arrival time. If a data burst arrives at the DS-TT before the pre-defined burst arrival time, the DS-TT will hold it and forward to the next node at the pre-defined burst arrival time. For UL transmission, the UPF may obtain the burst arrival time and periodicity from the AMF, based on which the NW-TT may determine each burst arrival time. If a data burst arrives at the NW-TT before the pre-defined burst arrival time, the NW-TT will hold it and forward to the next node at the pre-defined burst arrival time.

For synchronization purpose, multiple GM clocks may be provisioned in a 1:m (active: standby) configuration for the 5GS and/or TSN. One of the GM clock may act as an active GM clock, whereas other GM clocks may act as standby GM clocks. When the active GM clock fails or degrade, a standby GM clock will take over. There exists a short transition period when a GM clock switchover occurs, in which data packet in the 5GS may be timestamped based on either the old active GM clock or the newly active GM clock. In order to process the data packet correctly, correct timing is required. Therefore, a DS/TT and/or NW-TT may need to be able to identify the right clock basis (for the timestamp in the data packet). That is, it is critical to be able to identify the right GM clock from the old active GM clock and the new active GM clock.

In this disclosure, various embodiments are disclosed, so a UE/DS-TT and/or a UPF/NW-TT may identify the right GM clock during a GM clock switchover.

Details on these embodiments are described below.

### Embodiment 1: 5GS Time Synchronization-5GS Detecting Grand Master Clock Switch

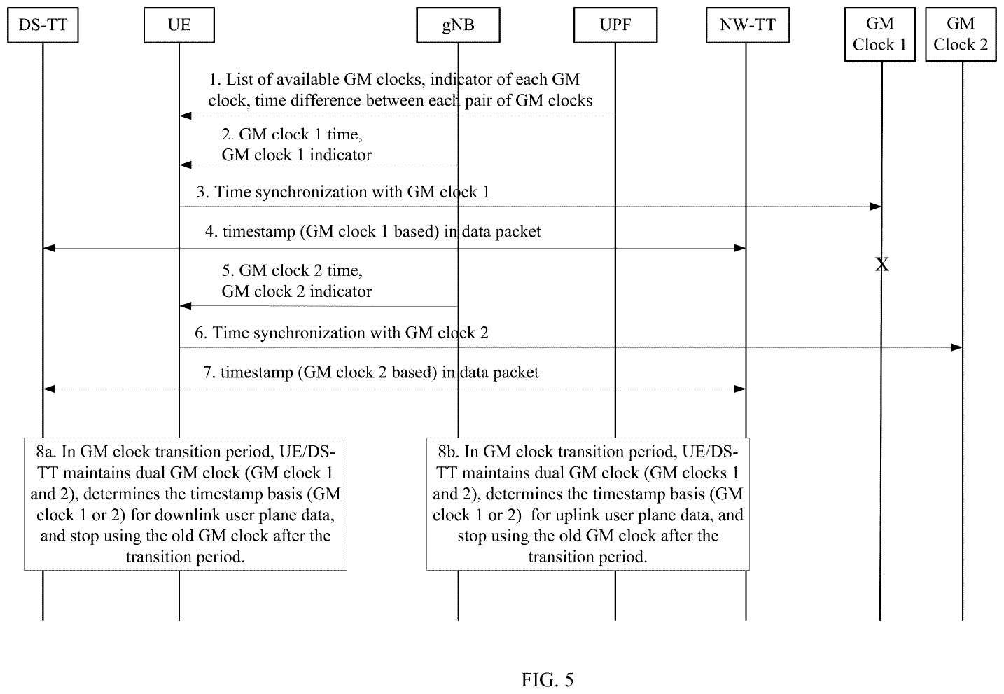

When a 5GS is acting as a TSN bridge, there are at least two Grand Master (GM) clocks provisioned in the system. As shown in FIG. 5, two GM clocks, GM clock 1 and GM clock 2 are provisioned. In some example implementations, at a given moment, one GM clock may act as an active clock and other GM clock(s) may act as standby clock(s). When the active clock fails or degrades (e.g., accuracy below a threshold), a switchover may occur so the standby GM clock may take over and become the active GM clock. In some example implementations, not shown in FIG. 5, there may be more than one standby GM clocks be provisioned.

FIG. 5 shows exemplary message flow and interactions among various network elements in a 5G System (5GS) for implementing time synchronization based on GM clock(s). The 5GS may include a core network and at least one base station (e.g., a gNB), and may further include multiple UEs. In the core network, among other network elements, there is a UPF, and a network side TSN Translator (NW-TT). On the UE side, the UE may include a device side TSN Translator (DS-TT). The DS-TT may be implemented as, for example, a hardware module or a software module in the UE.

### Step 1

From the 5GS side, the UPF may provide GM clock information to the UE. The GM clock information may include at least one of: a list of available GM clocks; a clock indicator of each GM clock in the list of available GM clocks; or a time difference between each pair of GM clocks in the list of available GM clocks. The clock indicator may include one of: a name, an identifier, or an index of each GM clock.

Alternatively, the gNB may provide the GM clock information to the UE.

If there is an update on the GM clock information, the UPF and/or gNB may send updated GM clock information to the UE, so the UE will have the up-to-date GM clock information.

The list of available GM clocks may include an active GM clock which is currently used by the 5GS, and at least one backup GM clock that the 5GS may switch to.

The time difference between two GM clocks may include: a time offset between the two GM clocks; or an absolute time of each of the two GM clocks (i.e., the time difference is implicit and may be derived based on the absolute time). Based on the time difference, when a switchover occurs, the UE may derive the time of the new GM clock (which becomes active) based on the old GM clock (i.e., the failed or degraded GM clock which is previously active). The UE may also be able to derive the time of the previously active GM clock based on the new active GM clock and the time difference between the new GM clock and the old GM clock.

As an example, referring to FIG. 5, the UPF provides to the UE a list of available GM clocks which includes GM clock 1 and GM clock 2. In this example, GM clock 2 is slower than GM clock 1 by 1 μμs (microsecond). If a switchover occurs (which is shown in later step), the UE may derive the time of GM clock 2 by subtracting 1 μs from the time of GM clock 1.

The GM clock information may be provided from UPF to UE by Non-Access Stratum (NAS) message. The GM clock information may also be provided from gNB to UE by Access Stratum (AS) message (e.g., System Information Block (SIB), or dedicated signaling). The gNB may obtain the GM clock information in various manners. For example, the gNB may obtain the GM clock information: 1) from UPF via non-UE associated signaling; or 2) from an Operations Administration & Maintenance (OAM) platform.

### Step 2

In this step, the 5GS is synchronizing its time with GM clock 1 (i.e., GM clock 1 is active). Specifically, UPF and/or gNB may obtain a time from GM clock 1 based on one of: a local on-site Global Navigation Satellite System (GNSS) receiver, a local on-site clock; or a cascaded Precision Time Protocol (PTP) capable transport network connection. The gNB may then deliver the time information (which is based on GM clock 1) to UE via AS signaling (e.g. SIB or dedicated Radio Resource Control (RRC) signaling). The time information may include at least one of: an absolute time of the GM clock 1; or a clock indicator of the GM clock 1.

### Step 3

The time information sent to the UE in step 2 may indicate to the UE that GM clock 1 is active. The UE proceeds to synchronize with GM clock 1.

### Step 4

When processing data packet (e.g., user plane data packet, such as a data packet for a generalized Precision Time Protocol (gPTP) message), NW-TT/UE-TT adds timestamp in the data packets based on GM clock 1. The timestamp may be stamped when the data packet enters the 5GS and the timestamp may be referred to as a 5GS ingress timestamp. For example, a downlink data packet may be stamped when the data packet enters the UPF or the NW-TT, and an uplink data packet be stamped when the data packet enters the UE-TT. The timestamp basis represents which GM clock is used when add the timestamp. In this step, the timestamp basis is GM clock 1.

### Step 5

The GM clock 1 fails or degrades. Correspondingly, the 5GS switches to GM clock 2. Specifically, the UPF and gNB obtain their time from GM clock2 based on one of: a local on-site GNSS receiver, a local on-site clock, or a cascaded PTP capable transport network connection. The gNB may then deliver the time information (which is based on GM clock 2) to UE via AS signaling (e.g. SIB or dedicated RRC signaling). The time information may include at least one of: an absolute time of the GM clock 2; a GM clock switching indication; or a clock indicator of the GM clock 2.

### Step 6

Upon receiving the time information sent by gNB in step 5, the UE may determine that there is a GM clock switchover based on the GM clock switching indication or the clock indicator which implicitly indicates a GM clock change. The UE may then proceed to synchronize with GM clock 2. For example, if the clock indicator indicates a different clock than the current clock, it indicates that there is a GM clock switchover. The clock indicator may include an identification of the clock, which may be a pre-defined clock indicator for each clock and may be used to uniquely identify the clock in the scope of UE, gNB and UPF. The clock indicator may include a GM clock index, a GM clock name, a GM clock identifier, and the like.

In one implementation, the DS-TT may implement the logic for detecting the GM clock switching.

The UE proceeds to synchronize its timing with GM clock 2 which becomes the active GM clock.

### Step 7

NW-TT/UE-TT adds timestamp in data packets (e.g., user plane data packet, such as gPTP message) based on GM clock 2. In this step, the timestamp basis is GM clock 2.

### Step 8

Based on the responsible entity (UE/DS-TT, or UPF/NW-TT) and the direction of user plane data, step 8 is split into step 8a, which covers UE/DS-TT when processing downlink user plane data, and step 8b, which covers UPF/NW-TT when processing uplink user plane data.

### Step 8a

When a GM clock switchover occurs, there is a GM clock transition period in which the GM clock switchover is performed. In the GM clock transition period, there may exist a race condition, for example, for data packet served/processed during the transition period. For a downlink UE data packet such as a data packet for a gPTP message, the NW-TT may add a timestamp when the data packet enters the 5GS. As described earlier, this timestamp may be referred to as an 5GS ingress timestamp. Depending on the timing of the GM clock switchover, the timestamp may be based on GM clock 1 (e.g., before the switchover commits), or GM clock 2 (e.g., after the switchover commits). When the data packet arrives at the UE, for synchronization purpose, the UE may need to process the data packet using the same clock which is used for adding the ingress timestamp. In a race condition, the UE may already know about the GM clock switchover and GM clock 2 is taking over. However, a data packet arrives after the switchover may still use the ingress timestamp based on GM clock 1. This may happen due to the transmission and processing delay of the data packet, which may be introduced in the 5GS as well as the in the air interface. For example, the ingress timestamp may be added before the switchover, but due to processing and transmission delay, when the data packet arrives at the UE, a GM clock switchover already commits. Therefore, rather than dropping the previously active clock (e.g., GM clock 1 as shown in FIG. 5), in the transition period, the UE/DS-TT may need to maintain dual GM clocks: the newly active GM clock 2 (new GM clock for simplicity), and the previously active GM clock 1 (old GM clock for simplicity).

For downlink user plane data, upon UE/DS-TT detecting the GM clock switching, the UE/DS-TT may determine the timestamp basis (i.e., whether the 5GS ingress timestamp in the downlink user plane data (e.g., in gPTP message) uses the new GM clock or the old GM clock) based on the 5GS time delay information. The 5GS time delay may be the duration between the moment that the 5GS ingress timestamp is added and the moment when the downlink user plane data is received by the UE/NW-TT.

In one implementation, if the 5GS time delay is invalid when derived based on the old GM clock and is valid when derived based on the new GM clock, then the UE/DS-TT may determine that the 5GS ingress timestamp of the downlink user plane data is based on the new GM clock. Otherwise if the 5GS time delay is invalid based on the new GM clock and is valid based on the old GM clock, then the UE/DS-TT may determine that the 5GS ingress timestamp is based on the old GM clock.

In one implementation, if the delay is a negative value, is too small (below a first threshold), or is too large (above a second threshold), then the delay is invalid. In other words, the delay may need to be within a delay range (as defined by the first threshold and the second threshold) to be valid. The delay range may be associated with the processing delay and transmission delay of the downlink user plane data. In one implementation, the delay range (or the first threshold and the second threshold) may be determined by the 5GS and signaled to the UE/DS-TT. In one implementation, the UE/DS-TT may derive the delay range (or the first threshold and the second threshold), for example, based on history statistics.

In one implementation, the timestamp basis may be determined based on the reception time sequence of the user plane data and the indication for GM clock switchover. For example, if the user plane data is received before the indication for GM clock switchover is received, then the timestamp basis for the 5GS ingress timestamp of the user plane data is the old GM clock. Otherwise, the timestamp basis is the new GM clock.

In one implementation, when re-transmission (e.g., via Hybrid Automatic Repeat Request (HARQ)) is performed for the user plane data and/or the indication for GM clock switchover, the reception time of the user plane data and the reception time of the indication for GM clock switchover is measured using the first downlink grant time (not the grant time for re-transmission).

In one implementation, if the delay is more credible if measured based on the new GM clock, then the timestamp basis for the 5GS ingress timestamp of the user plane data is the new GM clock, and vice versa.

In one implementation, during the transition period, the time of the old GM clock may be derived from the new GM clock, for example, based on the time difference.

In one implementation, after the transition period, the UE/DS-TT may stop using, or discarding the old GM clock. The duration of the transition period may be predefined, such as 1 millisecond, or signaled by the 5GS. Alternatively, the duration of the transition period may be derived by the UE, for example, based on history statistics.

In one implementation, once there is no more service that is based on the old GM clock, the UE/DS-TT may stop using, or discarding the old GM clock.

### Step 8b

When a GM clock switchover occurs, in the GM clock transition period, there may exist a race condition, for example, for data packet served/processed during the transition period. For an uplink UE data packet such as a data packet for a gPTP message, the DS-TT may add a timestamp when the data packet enters the DS-TT (or the UE). The timestamp may be referred to as an 5GS ingress timestamp (for data packet entering the 5GS from UE side). Depending on the timing of the GM clock switchover, the timestamp may be based on GM clock 1 (e.g., before the switchover commits), or GM clock 2 (e.g., after the switchover commits). When the data packet arrives at the core network (e.g., UPF or NW-TT), for synchronization purpose, the UPF may need to process the data packet using the same clock which is used for adding the ingress timestamp. In a race condition, the core network may already know about the GM clock switchover and GM clock 2 is taking over. However, the uplink data packet arrives after the switchover may still use the ingress timestamp based on GM clock 1. This may happen due to the transmission and processing delay of the data packet, which may be introduced in the 5GS as well as the in the air interface. For example, the ingress timestamp may be added to the uplink data before the switchover, but due to processing and transmission delay, when the uplink data packet arrives at the core network, a GM clock switchover already commits. Therefore, rather than dropping the previous active clock (e.g., GM clock 1 as shown in FIG. 5), in the transition period, the UPF/NW-TT may need to maintain dual GM clocks: the new GM clock 2, and the old GM clock 1.

For uplink user plane data, upon UPF/NW-TT detecting the GM clock switching, the UPF/NW-TT may determine the timestamp basis (i.e., whether the 5GS ingress timestamp in the uplink user plane data (e.g., in gPTP message) uses the new GM clock or the old GM clock) based on the 5GS time delay information, similar as in step 8a. The UPF/NW-TT may then select a GM clock based on the determined timestamp basis and process the uplink data using the selected GM clock.

In one implementation, after the transition period, the UPF/NW-TT may stop using, or discarding the old GM clock. The duration of the transition period may be predefined, such as 1 millisecond. Alternatively, the duration of the transition period may be derived by the UPF/NW-TT, for example, based on history statistics.

In one implementation, once there is no more service that is based on the old GM clock, the UPF/NW-TT may stop using, or discarding the old GM clock.

It is noted that the transition period in step 8b and step 8a may be the same, or different. The choice or determination of the transition period may be based on a practical deployment requirement.

### Embodiment 2: Time Synchronization-5GS Detecting Grand Master Clock Switch

In this embodiment, the core network may initiate the GM clock switchover and notify the UE/DS-TT. The notification may be based on a clock value tag or an explicit GM clock switchover indication. More details will be described in details in steps below.

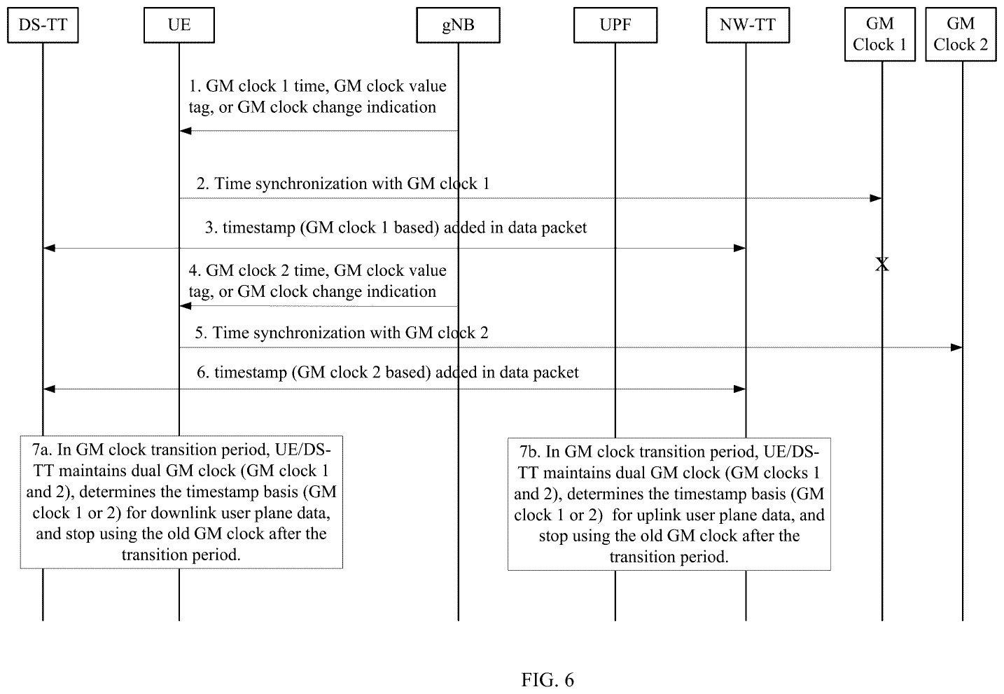

When a 5GS is acting as a TSN bridge, there are at least two Grand Master (GM) clocks provisioned in the system. As shown in FIG. 6, two GM clocks, GM clock 1 and GM clock 2 are provisioned. In some example implementations, at a given moment, one GM clock may act as an active clock and the other GM clock may act as a standby clock. When the active clock fails or degrades (e.g., accuracy below a threshold), a switchover may occur so the standby GM clock may take over and become the active GM clock. In some example implementations, not shown in FIG. 6, there may be more than one standby GM clocks be provisioned.

FIG. 6 shows exemplary message flow and interactions among various network elements in a 5GS for implementing time synchronization based on GM clock(s). The 5GS may include a core network and at least one base station (e.g., a gNB), and may further include multiple UEs. In the core network, among various network elements, there is a UPF, and a NW-TT. On the UE side, the UE may include a DS-TT.

### Step 1

In this step, the 5GS is synchronizing its time with GM clock 1 (i.e., GM clock 1 is active). Specifically, UPF and/or gNB may obtain a time from GM clock 1 based on one of: a local on-site Global Navigation Satellite System (GNSS) receiver, a local on-site clock; or a cascaded Precision Time Protocol (PTP) capable transport network connection. The gNB may then deliver clock information (which is based on GM clock 1) to UE via AS signaling (e.g. SIB or dedicated RRC signaling). The clock information may include at least one of: an absolute time of GM clock 1; a GM clock value tag; or a clock switch indication used for indicating that the GM clock switching occurs. The clock value tag may be a number that increments if a GM clock switching occurs. If the clock value tag is the same as the clock value tag received from a previous message, then there is no GM clock switchover occurring. Otherwise, if the clock value tag changes (e.g., increments) from the previous clock value tag, then a GM clock switchover occurs.

In one implementation, the clock information for GM clock may be sent to the UE periodically, even there is no GM clock switchover. The UE may utilize the clock information to calibrate its timing periodically, to synchronize with the active GM clock.

### Step 2

Upon receiving the message sent to UE in step 1, UE decides that there is no GM clock switchover. The UE may choose to synchronize or re-synchronize with GM clock 1.

### Step 3

When processing data packet (e.g., user plane data packet, such as gPTP message), NW-TT/UE-TT adds timestamp (i.e., 5GS ingress timestamp) in the data packets based on GM clock 1. In this step, the timestamp basis is GM clock 1.

### Step 4

The GM clock 1 fails or degrades. Correspondingly, the 5GS switches to GM clock 2. Specifically, the UPF and gNB obtain their time from GM clock 2 based on one of: a local on-site GNSS receiver, a local on-site clock, or a cascaded PTP capable transport network connection. The gNB may then deliver clock information to UE via AS signaling. The clock information may include at least one of: an absolute time of GM clock 2; a GM clock value tag; or a clock switch indication used for indicating that the GM clock switching occurs. Note that the clock value tag changes (e.g., increments) from the clock value tag in step 1.

### Step 5

Upon receiving the clock information sent by gNB in step 4, the UE may determine that there is a GM clock switchover based on the clock switch indication or the GM clock value tag. The UE may then proceed to synchronize with GM clock 2.

The change of GM clock value tag from its previously received value indicates that there is a GM clock switchover. For example, the GM clock value tag may increment whenever there is a GM clock switchover occurs.

### Step 6

NW-TT/UE-TT adds timestamp in data packets (e.g., user plane data packet, such as gPTP message) based on GM clock 2.

### Step 7

Steps 7, 7a, and 7b are similar to steps 8, 8a, and 8b in embodiment 1, respectively, and the details are skipped herein.

### Embodiment 3: 5GS Time Synchronization-UE Detecting Grand Master Clock Switch

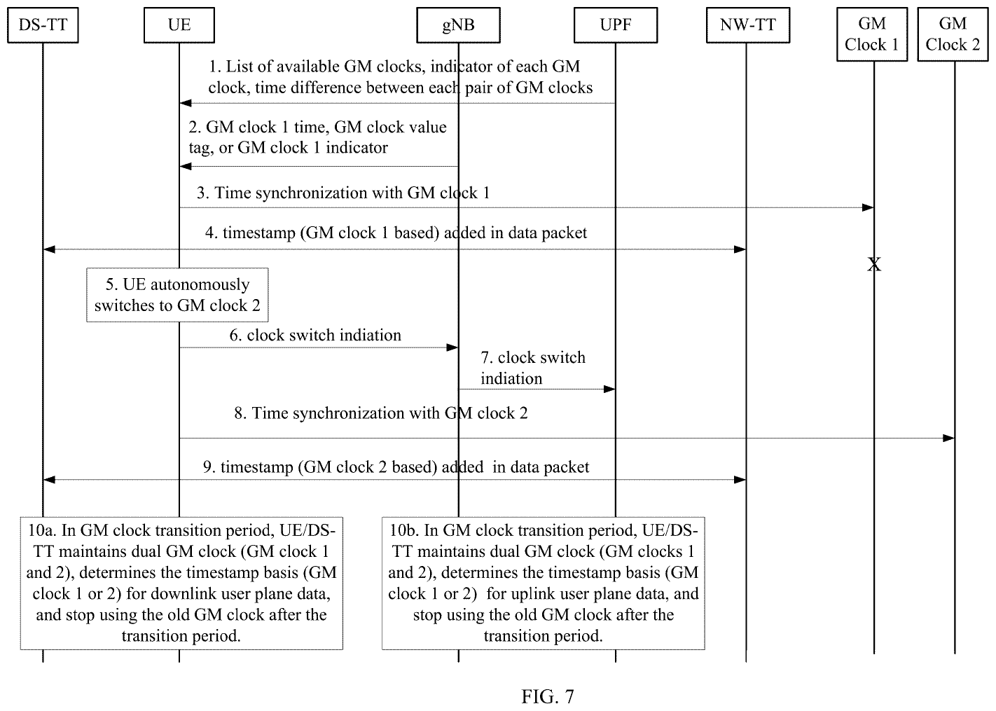

When a 5GS is acting as a TSN bridge, there are at least two Grand Master (GM) clocks provisioned in the system. As shown in FIG. 7, two GM clocks, GM clock 1 and GM clock 2 are provisioned. In some example implementations, at a given moment, one GM clock may act as an active clock and the other GM clock may act as a standby clock. When the active clock fails or degrades (e.g., accuracy below threshold), a switchover may occur so the standby GM clock may take over and become the active GM clock. In some example implementations, not shown in FIG. 7, there may be more than one standby GM clocks be provisioned.

FIG. 7 shows exemplary message flow and interactions among various network elements in a 5GS for implementing time synchronization based on GM clock(s). The 5GS may include a core network and at least one base station (e.g., a gNB), and may further include multiple UEs. In the core network, there is a UPF, and a NW-TT. On the UE side, the UE may include a DS-TT.

### Step 1

Step 1 is similar to step 1 in embodiment 1, and the details are skipped herein.

### Step 2

In this step, the 5GS is synchronizing its time with GM clock 1 (i.e., GM clock 1 is active). Specifically, UPF and/or gNB may obtain a time from GM clock 1 based on one of: a local on-site GNSS receiver, a local on-site clock; or a cascaded Precision Time Protocol (PTP) capable transport network connection. The gNB may then deliver clock information (which is based on GM clock 1) to UE via AS signaling (e.g. SIB or RRC signaling). The clock information may include at least one of: an absolute time of the GM clock 1; a GM clock value tag; or a clock indicator of the GM clock 1.

### Step 3

The clock information sent to the UE in step 2 may indicate to the UE that GM clock 1 is active. The UE proceeds to synchronize with GM clock 1.

### Step 4

When processing data packet (e.g., user plane data packet, such as gPTP message), NW-TT/UE-TT adds timestamp (i.e., 5GS ingress timestamp) in the data packets based on GM clock 1. The timestamp basis is GM clock 1.

### Step 5

UE detect that the GM clock 1 fails or degrades. Correspondingly, the UE autonomously switches to GM clock 2. Specifically, the UE may receive its time from GM clock 2, for example, by receiving GNSS clock directly.

### Step 6

The UE may provide a clock switch indication to the gNB via an AS message, such as a MAC CE message, or a dedicated RRC message.

The clock switch indication may include an indicator of the GM clock 2. The indicator may be pre-defined, which can uniquely identify the clock in the UE and gNB. The indicator may include one of: a clock index, a clock name, or a clock identity.

### Step 7

The gNB may forward the clock switch indication to the UPF via a non-UE associated signaling or a UE associated signaling.

Alternatively, not shown in FIG. 7, the UE may send the clock switch indication to UPF directly via a NAS message.

### Step 8

The UE may then proceed to synchronize with GM clock 2. Note that step 8 may be performed right after step 5 before step 6. Or step 8 may be performed in parallel with step 6 and/or step 7.

### Step 9

NW-TT/UE-TT adds timestamp in data packets (e.g., user plane data packet, such as gPTP message) based on GM clock 2.

### Step 10

Steps 10, 10a, and 10b are similar to steps 8, 8a, and 8b in embodiment 1, respectively, and the details are skipped herein.

### Embodiment 4: 5GS Time Synchronization with Clock Indicator in Timestamp

In this embodiment, when adding a timestamp in the 5GS ingress data packet, a clock indicator indicating the active GM clock is added in the timestamp, to explicitly indicate the timestamp basis.

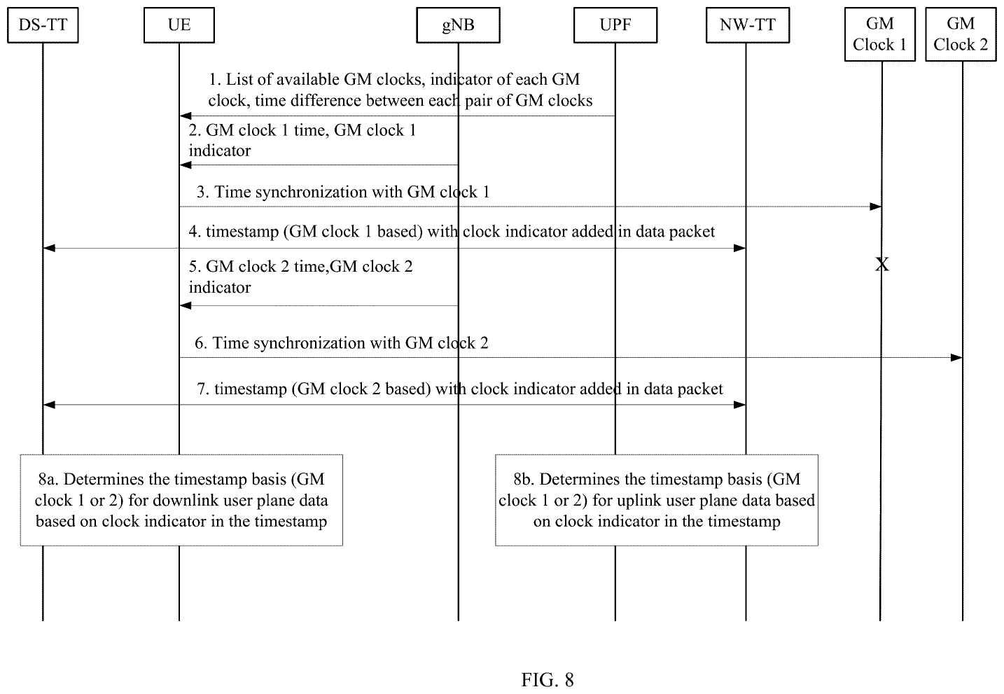

FIG. 8 shows exemplary message flow and interactions among various network elements in a 5GS for implementing time synchronization based on GM clock(s). The 5GS may include a core network and at least one base station (e.g., a gNB), and may further include multiple UEs. In the core network, there is a UPF, and a NW-TT. On the UE side, the UE may include a DS-TT.

### Step 1

Step 1 is similar to step 1 in embodiment 1, and the details are skipped herein.

### Step 2

In this step, the 5GS is synchronizing its time with GM clock 1 (i.e., GM clock 1 is active). Specifically, UPF and/or gNB may obtain a time from GM clock 1 based on one of: a local on-site GNSS receiver, a local on-site clock; or a cascaded Precision Time Protocol (PTP) capable transport network connection. The gNB may then deliver clock information (which is based on GM clock 1) to UE via AS signaling (e.g. SIB or RRC signaling). The clock information may include at least one of: an absolute time of the GM clock 1; or a clock indicator of the GM clock 1.

### Step 3

The clock information sent to the UE in step 2 may indicate to the UE that GM clock 1 is active. The UE proceeds to synchronize with GM clock 1.

### Step 4

When processing data packet (e.g., user plane data packet, such as gPTP message), NW-TT/UE-TT adds timestamp (i.e., 5GS ingress timestamp) in the data packets based on GM clock 1. To explicitly indicate the timestamp basis (which is GM clock 1), the NW-TT/UE-TT may add a clock indicator of GM clock 1 either in the timestamp, or in another field co-exists with the timestamp.

### Step 5

The GM clock 1 fails or degrades. Correspondingly, the 5GS switches to GM clock 2. Specifically, the UPF and gNB obtain their time from GM clock2 based on one of: a local on-site GNSS receiver, a local on-site clock, or a cascaded PTP capable transport network connection. The gNB may then deliver clock information (which is based on GM clock 2) to UE via AS signaling (e.g. SIB or dedicated RRC signaling). The clock information may include at least one of: an absolute time of the GM clock 2; or a clock indicator of the GM clock 2.

### Step 6

The UE may proceed to synchronize with GM clock 2, as indicated in step 5.

### Step 7

When processing data packet (e.g., user plane data packet, such as gPTP message), NW-TT/UE-TT adds timestamp (i.e., 5GS ingress timestamp) in the data packets based on GM clock 1. To explicitly indicate the timestamp basis (which is GM clock 2), the NW-TT/UE-TT may add a clock indicator of GM clock 2 either in the timestamp, or in another field co-exists with the timestamp.

### Step 8

Based on the responsible entity (UE/DS-TT, or UPF/NW-TT) and direction of user plane data, step 8 is split into step 8a, which covers UE/DS-TT when processing downlink user plane data, and step 8b, which covers UPF/NW-TT when processing uplink user plane data.

### Step 8a

For downlink user plane data, the UE/DS-TT may determine the timestamp basis (i.e., whether the 5GS ingress timestamp in the downlink user plane data (e.g., in gPTP message) uses the new GM clock or the old GM clock) based on the clock indicator added in the timestamp itself or in another field co-exists with the timestamp.

### Step 8b

For uplink user plane data, the UPF/NW-TT may determine the timestamp basis (i.e., whether the 5GS ingress timestamp in the downlink user plane data (e.g., in gPTP message) uses the new GM clock or the old GM clock) based on the clock indicator added in the timestamp itself or in another field co-exists with the timestamp.

In this disclosure, for at least the purpose of saving energy consumption at a base station, a DTX mode is introduced. The DTX mode may apply to various levels targeting different granularities. For example, the DTX may apply to a cell level, a cell group level, a DU level, a DU group level, a base station level, or the like. In this disclosure, description may be made under the cell level for exemplary purpose. The same underlying principle applies to other levels as well.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution may be practiced without one or more of the specific features or advantages of a particular embodiment. In other instances, additional features and advantages may be recognized in certain embodiments that may not be present in all embodiments of the present solution.

1. A method for clock synchronization, performed by a wireless device in a 5G System (5GS), the method comprising:
receiving, from a first network element in the 5GS, a first message comprising clock configuration information, the clock configuration information comprising at least one of:
a list of Grand Master (GM) clocks comprising at least a first GM clock and a second GM clock;
a clock indicator of each GM clock in the list of GM clocks, the clock indicator comprising at least one of:
a name of the each GM clock in the list of GM clocks;
an identifier of the each GM clock in the list of GM clocks; or
an index of the each GM clock in the list of GM clocks;
a time difference between the first GM clock and the second GM clock;
receiving, from a second network element the 5GS, a first clock information for the first GM clock;
in response to the first clock information, using the first GM clock as an active GM clock; and
synchronizing with the 5GS based on the first clock information and treating the first GM clock as an active GM clock.

2. The method of claim 1,
wherein the time difference between the first GM clock and the second GM clock comprises at least one of:
a time offset between the first GM clock and the second GM clock; or
an absolute time of each of the first GM clock and the second GM clock;
wherein the first clock information comprises at least one of the absolute time of the first GM clock or a clock indicator of the first GM clock;
wherein the first network element comprises at least one of a User Plane Function (UPF) or a network side time sensitive network translator (NW-TT), and
wherein the second network element comprises a base station, the base station comprising at least one of a gNodeB (gNB), an eNodeB (eNB), an ng-eNodeB (ng-eNB), or a NodeB.

3. (canceled)

4. The method of claim 1, further comprising:
determining the active GM clock switching from the first GM clock to the second GM clock; and
determining a timestamp basis for an ingress timestamp of a user plane data packet when the user plane data packet enters the 5GS, wherein the user plane data packet is a downlink user plane data packet or a packet for a generalized PTP (gPTP) message, and wherein:
the timestamp basis comprises a first timestamp basis based on the first GM clock and a second timestamp basis based on the second GM clock; and
the ingress timestamp of the user plane data packet is stamped by a network side time sensitive network translator (NW-TT) in the 5GS upon receiving the user plane data packet by the NW-TT.

5-6. (canceled)

7. The method of claim 4, further comprising:
processing the user plane data packet based on the timestamp basis.

8-10. (canceled)

11. The method of claim 4, wherein determining the timestamp basis for the ingress timestamp of the user plane data packet comprises:
determining a second delay of the user plane data packet in the 5GS based on the second GM clock, wherein the second delay is associated with: the ingress timestamp of the user plane data packet; and a reception time of the user plane data packet by the wireless device measured using the second GM clock;
determining whether the second delay is valid; and
in response to the second delay being valid, determining that the timestamp basis for the ingress timestamp of the user plane data packet is the second timestamp basis; or
determining a first delay of the user plane data packet in the 5GS based on the first GM clock, wherein the first delay is associated with: the ingress timestamp of the user plane data packet; and a reception time of the user plane data packet by the wireless device measured using the first GM clock;
determining whether the first delay is valid by:
in response to the first delay satisfying one of following conditions:
the first delay being negative;
the first delay being below a first threshold; or
the first delay being above a second threshold,
determining that the first delay is invalid; and
in response to the first delay being above the first threshold and below the second threshold, determining that the first delay is valid,
wherein the first threshold and the second threshold are predetermined or signaled from the 5GS to the wireless device; and
in response to the first delay being valid, determining that the timestamp basis for the ingress timestamp of the user plane data packet is the first timestamp basis; or
determining the timestamp basis for the ingress timestamp of the user plane data packet based on a clock indicator in the ingress timestamp; or
determining a first delay of the user plane data packet in the 5GS based on the first GM clock, wherein the first delay is associated with: the ingress timestamp of the user plane data packet; and a reception time of the user plane data packet by the wireless device measured using the first GM clock;
determining a second delay of the user plane data packet in the 5GS based on the second GM clock, wherein the second delay is associated with: the ingress timestamp of the user plane data packet; and a reception time of the user plane data packet by the wireless device measured using the second GM clock; and
in response to both the first delay and the second delay being valid, selecting a more credible delay from the first delay and the second delay, and determining the timestamp basis for the ingress timestamp based on the more credible delay.

12. The method of claim 4, wherein:
before determining, that the active GM clock switches from the first GM clock to the second GM clock, the method further comprises:
receiving, from the 5GS, a second clock information for the second GM clock, wherein the second clock information comprises at least one of: an absolute time of the second GM clock; or an identifier of the second GM clock indicating a GM clock switchover to the second GM clock; and
determining the timestamp basis for the ingress timestamp of the user plane data packet comprises:
in response to a reception time of the user plane data packet by the wireless device being earlier than a reception of the second clock information, determining that the timestamp basis for the ingress timestamp of the user plane data packet is the first timestamp basis; and
in response to the reception time of the user plane data packet by the wireless device being earlier than the reception of the second clock information, determining that the timestamp basis for the ingress timestamp of the user plane data packet is the second timestamp basis.

13-14. (canceled)

15. The method of claim 4, wherein:
the first clock information further comprises a clock indicator of the first GM clock;
determining the active GM clock switching from the first GM clock to the second GM clock comprises:
receiving, from the 5GS, a second clock information for the second GM clock, the second clock information comprises at least one of: an absolute time of the second GM clock; or a clock indicator of the second GM clock; and
determining the active GM clock switching from the first GM clock to the second GM clock in response to the clock indicator in the second clock information being different with the clock indicator in the first clock information.

16. (canceled)

17. The method of claim 4, wherein:
the first clock information further comprises at least one of: a clock value tag which increments if a GM clock switching occurs; or a clock switch indication used for indicating that the GM clock switching occurs; and
determining the active GM clock switching from the first GM clock to the second GM clock comprises:
receiving, from the 5GS, a second clock information for the second GM clock, the second clock information comprises at least one of: the clock value tag, or the clock switch indication;
determining the active GM clock switching from the first GM clock to the second GM clock in response to one of:
the clock value tag incrementing from its previous value; or
the clock switch indication indicating that the GM clock switching occurs.

18. The method of claim 4, further comprising:
transmitting, to the 5GS, a second message comprising a GM clock switching indication, the GM clock switching indication comprising a clock indicator of the second GM clock by:
transmitting, to a base station in the 5GS, the second message via an Access Stratum (AS) message comprising at least one of: a Medium Access Control-Control Element (MAC CE) message, or a Radio Resource Control (RRC) message; wherein a reception of the second message by the base station triggers the base station to forward the second message to a User Plane Function (UPF) in the 5GS via a UE associated signaling; or
transmitting, to a User Plane Function (UPF) in the 5GS, the second message via a Non-Access Stratum (NAS) message,
wherein determining the active GM clock switching from the first GM clock to the second GM clock comprises:
in response to detecting that the first GM clock fails or degrades, determining the active GM clock switching from the first GM clock to the second GM clock.

19-20. (canceled)

21. The method of claim 4, further comprising:
in determination that there is no service being based on the first GM clock, or there is no user data packet being based on the first GM clock, stopping using, or discarding the first GM clock.

22-23. (canceled)

24. A method for clock synchronization, performed by a first network element in a 5GS, the method comprising:
transmitting, to a wireless device in the 5GS, a first message comprising clock configuration information, the clock configuration information comprising at least one of:
a list of Grand Master (GM) clocks comprising at least a first GM clock and a second GM clock;
a clock indicator of each GM clock in the list of GM clocks, the clock indicator comprising at least one of:
a name of the each GM clock in the list of GM clocks;
an identifier of the each GM clock in the list of GM clocks; or
an index of the each GM clock in the list of GM clocks;
a time difference between the first GM clock and the second GM clock;
transmitting, to the wireless device, a first clock information for the first GM clock, wherein the first clock information indicating that the first GM clock is an active GM clock; and
treating the first GM clock as an active GM clock.

25. The method of claim 24,
wherein the time difference between the first GM clock and the second GM clock comprises at least one of:
a time offset between the first GM clock and the second GM clock; or
an absolute time of each of the first GM clock and the second GM clock;
wherein the first clock information comprises at least one of the absolute time of the first GM clock or a clock indicator of the first GM clock; and
wherein the first network element comprises at least one of a User Plane Function (UPF) or a network side time sensitive network translator (NW-TT).

26. (canceled)

27. The method of claim 24, further comprising:
detecting that the first GM clock fails or degrades;
determining the active GM clock switching from the first GM clock to the second GM clock; and
transmitting, to the wireless device, a second message indicating the active GM clock switching from the first GM clock to the second GM clock.

28. The method of claim 27, further comprising:
adding the clock indicator in a timestamp of a downlink user plane data packet for the wireless device when the downlink user plane data packet enters the first network element, wherein the wireless device determines a clock basis for the downlink user plane data packet to be the second GM clock based on the clock indicator,
wherein the second message comprises at least one of a clock indicator of the second GM clock, a clock value tag which increments if a GM clock switching occurs, or a clock switch indication used for indicating that the GM clock switching occurs.

29-30. (canceled)

31. The method of claim 27, further comprising:
determining a timestamp basis for an ingress timestamp of a user plane data packet when the user plane data packet enters the 5GS, wherein the user plane data packet is an uplink user plane data packet, and wherein:
the timestamp basis comprises a first timestamp basis which is based on the first GM clock and a second timestamp basis which is based on the second GM clock; and
the ingress timestamp of the user plane data packet is stamped by a device side time sensitive network translator (DS-TT) in the 5GS upon receiving the user plane data packet by the DS-TT.

32. (canceled)

33. The method of claim 31, further comprising:
processing the user plane data packet based on the timestamp basis.

34-36. (canceled)

37. The method of claim 31, wherein determining the timestamp basis for the ingress timestamp of the user plane data packet comprises:
determining a second delay of the user plane data packet in the 5GS based on the second GM clock, wherein the second delay is associated with: the ingress timestamp of the user plane data packet; and a reception time of the user plane data packet by the wireless device measured using the second GM clock;
determining whether the second delay is valid; and
in response to the second delay being valid, determining that the timestamp basis for the ingress timestamp of the user plane data packet is the second timestamp basis; or
determining a first delay of the user plane data packet in the 5GS based on the first GM clock, wherein the first delay is associated with: the ingress timestamp of the user plane data packet; and a reception time of the user plane data packet by the first network element measured using the first GM clock;
determining whether the first delay is valid by:
in response to the first delay satisfying one of following conditions:
the first delay being negative;
the first delay being below a first threshold; or
the first delay being above a second threshold,
determining that the first delay is invalid; and
in response to the first delay being above the first threshold and below the second threshold, determining that the first delay is valid,
wherein the first threshold and the second threshold are predetermined or derived by the 5GS; and
in response to the first delay being valid, determining that the timestamp basis for the ingress timestamp of the user plane data packet is the first timestamp basis; or
determining the timestamp basis based on a clock indicator in the ingress timestamp; or
determining a first delay of the user plane data packet in the 5GS based on the first GM clock, wherein the first delay is associated with: the ingress timestamp of the user plane data packet; and a reception time of the user plane data packet by the wireless device measured using the first GM clock;
determining a second delay of the user plane data packet in the 5GS based on the second GM clock, wherein the second delay is associated with: the ingress timestamp of the user plane data packet; and a reception time of the user plane data packet by the wireless device measured using the second GM clock; and
in response to both the first delay and the second delay being valid, selecting a more credible delay from the first delay and the second delay, and determining the timestamp basis for the ingress timestamp based on the more credible delay.

38-39. (canceled)

40. The method of claim 24, further comprising:
receiving, from the wireless device, a second message comprising a GM clock switching indication, the GM clock switching indication comprising a clock indicator of the second GM clock;
in response to the GM clock switching indication, determining the active GM clock switching from the first GM clock to the second GM clock; and
processing a user plane data packet based on the second GM clock.

41. (canceled)

42. A device for wireless communication comprising a memory for storing computer instructions and a processor in communication with the memory, wherein, when the processor executes the computer instructions, the processor is configured to implement a method comprising:
receiving, from a first network element in a 5G System (5GS), a first message comprising clock configuration information, the clock configuration information comprising at least one of:
a list of Grand Master (GM) clocks comprising at least a first GM clock and a second GM clock;
a clock indicator of each GM clock in the list of GM clocks, the clock indicator comprising at least one of:
a name of the each GM clock in the list of GM clocks;
an identifier of the each GM clock in the list of GM clocks; or
an index of the each GM clock in the list of GM clocks;
a time difference between the first GM clock and the second GM clock;
receiving, from a second network element the 5GS, a first clock information for the first GM clock;
in response to the first clock information, using the first GM clock as an active GM clock; and
synchronizing with the 5GS based on the first clock information and treating the first GM clock as an active GM clock.

43. A computer program product comprising a non-transitory computer-readable program medium with computer code stored thereupon, the computer code, when executed by one or more processors, causing the one or more processors to implement a method comprising:
receiving, from a first network element in a 5G System (5GS), a first message comprising clock configuration information, the clock configuration information comprising at least one of:
a list of Grand Master (GM) clocks comprising at least a first GM clock and a second GM clock;
a clock indicator of each GM clock in the list of GM clocks, the clock indicator comprising at least one of:
a name of the each GM clock in the list of GM clocks;
an identifier of the each GM clock in the list of GM clocks; or
an index of the each GM clock in the list of GM clocks;
a time difference between the first GM clock and the second GM clock:
receiving, from a second network element the 5GS, a first clock information for the first GM clock:
in response to the first clock information, using the first GM clock as an active GM clock; and
synchronizing with the 5GS based on the first clock information and treating the first GM clock as an active GM clock.
